(19) United States
(12) Patent Application Publication
(10) Pub. No.: US 2016/0368008 A1
(43) Pub. Date: Dec. 22, 2016

(54) SPRAY HEAD STRUCTURE SLIDABLY ASSEMBLED WITH A NUT

(71) Applicant: BEN-WHY LIAO, TAICHUNG (TW)

(72) Inventor: BEN-WHY LIAO, TAICHUNG (TW)

(73) Assignees: BEN-WHY LIAO, TAICHUNG (TW); I-HSIN LIAO, TAICHUNG (TW)

(21) Appl. No.: 15/243,890

(22) Filed: Aug. 22, 2016

Related U.S. Application Data
(63) Continuation-in-part of application No. 14/594,441, filed on Jan. 12, 2015.

(51) Int. Cl. B05B 7/30; B05B 15/06

(52) U.S. Cl. CPC B05B 7/30; B05B 15/065

(57) ABSTRACT

A spray head structure slidably assembled with a nut comprises a spray head, an air pipe, and a fixing nut. The fixing nut of the spray head may adjustably fix to the air pipe by screwing in and out. When fixing, one end of the outer threading section may be abutted against the washer to be deformed. The deformed washer may laterally press the air pipe so as to make the spray head fix to the air pipe. It may achieve that the liquid may be sucked normally and sprayed in normal high pressure.

### FIELD OF THE INVENTION

The present invention relates to a spray head, and more particularly to a spray head structure slidably assembled with a nut capable for adjusting the flow rate.

### BACKGROUND OF THE INVENTION

The conventional spray head for washing or painting the surface of the object is connected with a pneumatic supply and a liquid supply. The air pressure is inputted the air spray gun to perform Venturi effect so as to suck the liquid in the liquid supply. The press handlebar of the air spray gun is operated to adjust the air pressure to spray the liquid. The drawback of the conventional spray head is that the liquid is not able to be sucked or the pressure is too high to result in flowing reversely in the spray head. It needs to be improved.

In view of the foregoing circumstances, the inventor has invested a lot of time to study the relevant knowledge, compare the pros and cons, research and develop related products. After quite many experiments and tests, the “spray head structure” of this invention is eventually launched to improve the foregoing shortcomings, to meet the public use.

### SUMMARY OF THE INVENTION

An objective of this invention is providing a spray head structure slidably assembled with a nut. It may improve that the liquid is not able to be sucked or the pressure is too high to result in flowing reversely in the spray head.

To achieve above objectives, a spray head structure slidably assembled with a nut is provided and comprises a spray head, an air pipe, and a fixing nut, wherein: the spray head have an outlet member, the outlet member includes a hollow base, an outer threading section is formed at an inner edge of one end of the base, the outer threading section is screwed with an inner threading section of the fixing nut so that a tail end of the outer threading section is abutted against a washer of the fixing nut, an import end is formed in a bottom portion of the base, a head portion is formed at one end of the base, and a nuzzle is extended from the head portion; one end of the air pipe is arranged in the base of the spray head and the other end of the air pipe is detachably arranged a stop member; and one end of the fixing nut has an open end and the other end of the fixing end is passed through a central hole for providing the air pipe to pass through and stop at the stop member of the air pipe, a ring cavity is defined between the central hole and the inner threading section, one side of the ring cavity is formed a strop surface, the washer is received in the ring cavity, and one side of the washer is stopped be the stop surface.

Accordingly, the fixing nut of the spray head may adjustably fix to the air pipe by screwing in and out. When fixing, one end of the outer threading section may be abutted against the washer to be deformed. The deformed washer may laterally press the air pipe so as to make the spray head fix to the air pipe. It may achieve that the liquid may be sucked normally and sprayed in normal high pressure.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a perspective view of a spray head structure slidably assembled with a nut in accordance with the present invention.

FIG. 2 is an exploded view of the spray head structure in accordance with the present invention.

FIG. 3 is an operational view of the spray head structure in accordance with the present invention.

FIG. 4 is another operational view of the spray head structure in accordance with the present invention.

FIG. 5 is a perspective view of a spray head of the spray head structure slidably assembled with the nut in accordance with the present invention.

FIG. 6 is an exploded view of the spray head of the spray head structure slidably assembled with the nut in accordance with the present invention.

FIG. 7 is an operational view of the spray head of the spray head structure slidably assembled with the nut in accordance with the present invention.

FIG. 8 is another operational view of the spray head of the spray head structure slidably assembled with the nut in accordance with the present invention.

### DESCRIPTION OF THE PREFERRED EMBODIMENT

Referring now to the drawings where like characteristics and features among the various figures are denoted by like reference characters.

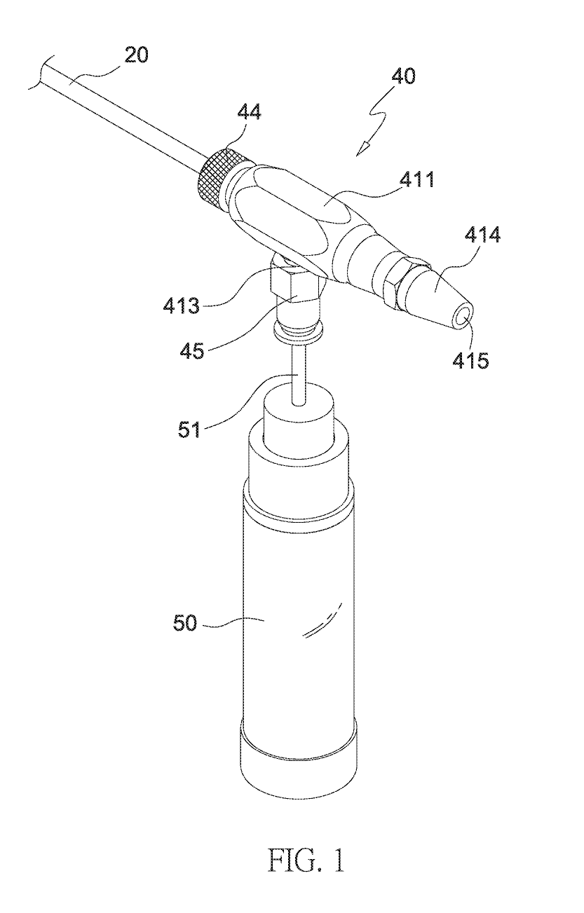

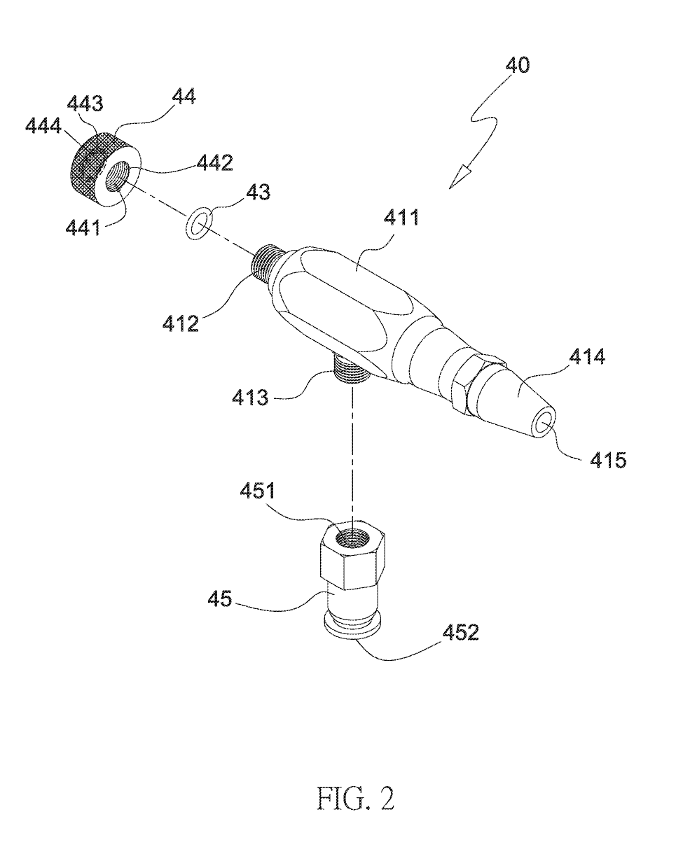

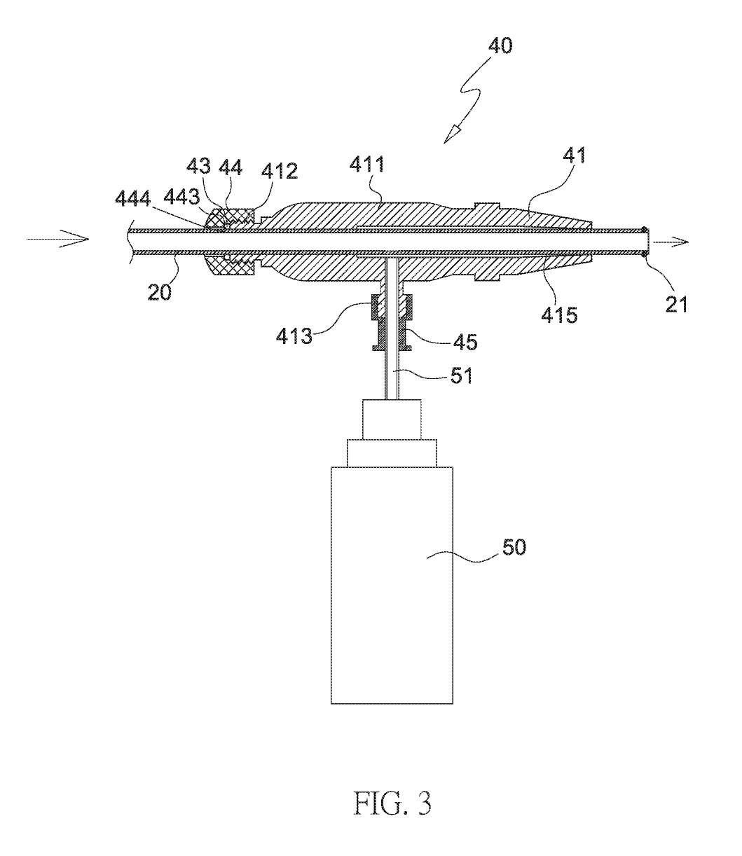

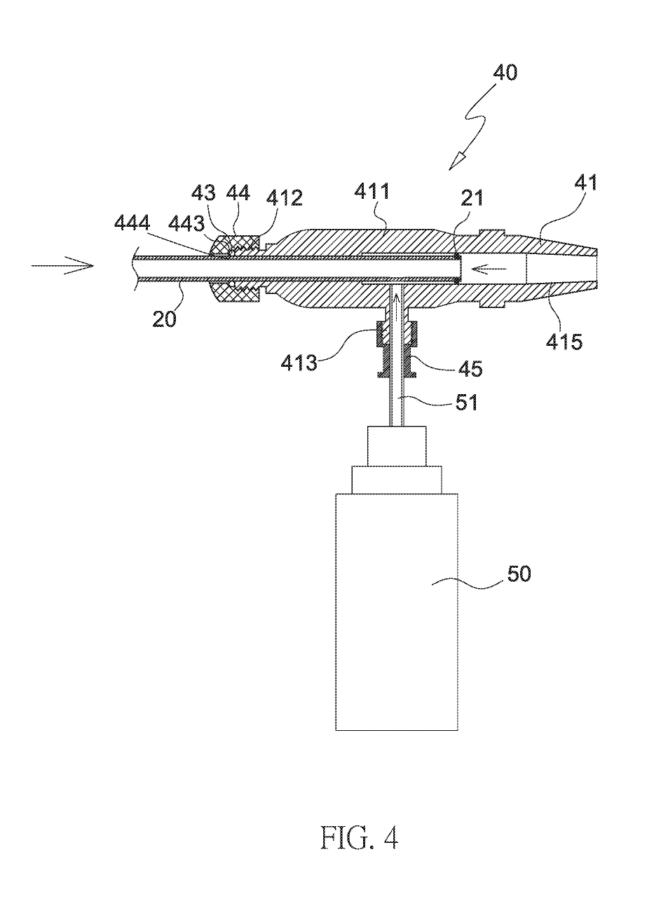

Please refer to FIGS. 1 to 4, the spray head of the spray head structure slidably assembled with a nut may comprise a spray head 40, an air pipe 20, and a fixing nut 44.

The spray head 40 is composed of an outlet member 41, the fixing nut 44, and a washer 43. The outlet member 41 includes a hollow base 411. An outer threading section 412 is arranged at an inner edge of one end of the base 411. An import end 413 is fluidly communicated with a bottom portion of the base 411. The import end 413 is connected with an assembly end 451 of a guiding base 45. One end of the guiding base 45 opposite to the assembly end 451 arranged a receiving end 452. A head portion 414 is arranged at a tail end of the base 411. A nozzle 415 is arranged at a tail end of the head portion 414. One end of the fixing nut 44 formed a U-shaped open end and the inner threading section 442 is formed at the inner edge of the fixing nut 44 so as to screw with the outer threading section 412. The other end of the fixing nut 44 is passed through a central hole 441 for providing the air pipe 20 to pass through. A ring cavity 443 is defined between the central hole 441 and the inner threading section 442. One side of the ring cavity 443 has a stop surface 444. The washer 43 is received in the ring cavity 443. One side of the washer 43 is stopped at the stop surface 444. The spray head 40 is slid to the tail end of the air pipe 20 relative to air pipe 20 after the air pipe 20 passes through the central hole 441 of the fixing nut 44. The fixing nut 44 is screwed tightly so that one end of the outer threading section 412 is abutted against the washer 43 and the washer 43 is deformed. The deformed washer 43 may laterally press the air pie 20 to make the spray head 40 fix to the air pipe 20.

A liquid bottle 50 has a liquid guiding pipe 51. The liquid guiding pipe 51 is fluidly communicated with the receiving end 452 of the guiding base 45 of the outlet member 41. Accordingly, when the air in the air pipe 20 is sprayed from the nozzle 415, the inside of the spray head 40 is in a negative pressure status so that the liquid in the liquid bottle 50 is sucked from the inside of the spray head 40 through the liquid guiding pipe 51. The liquid and the air are mixed and then sprayed from the nozzle 415 toward the outside to be atomized.

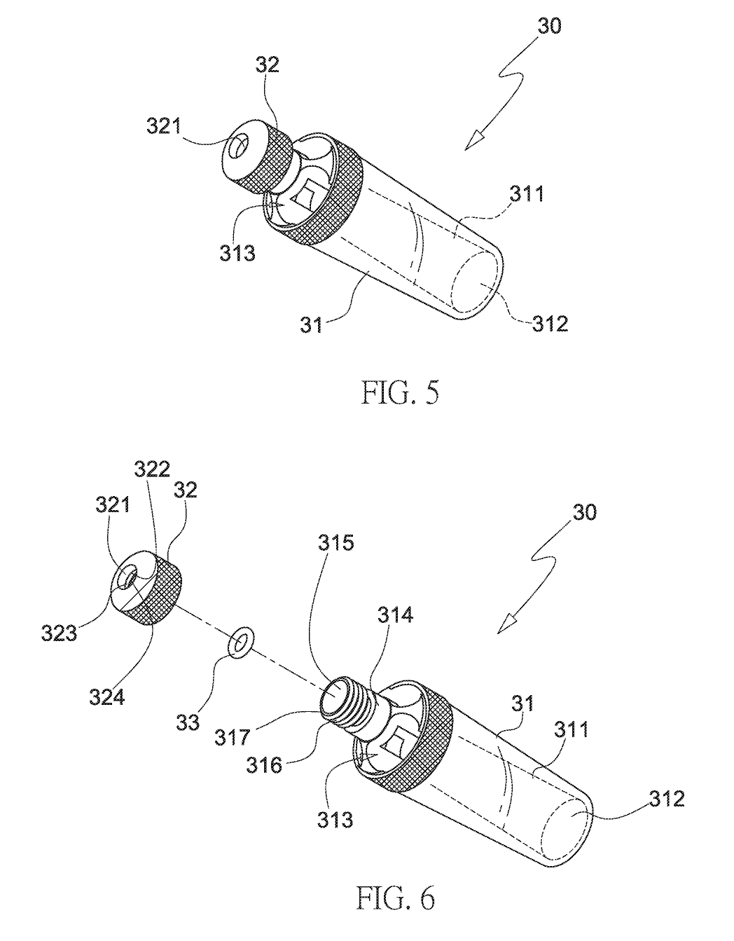

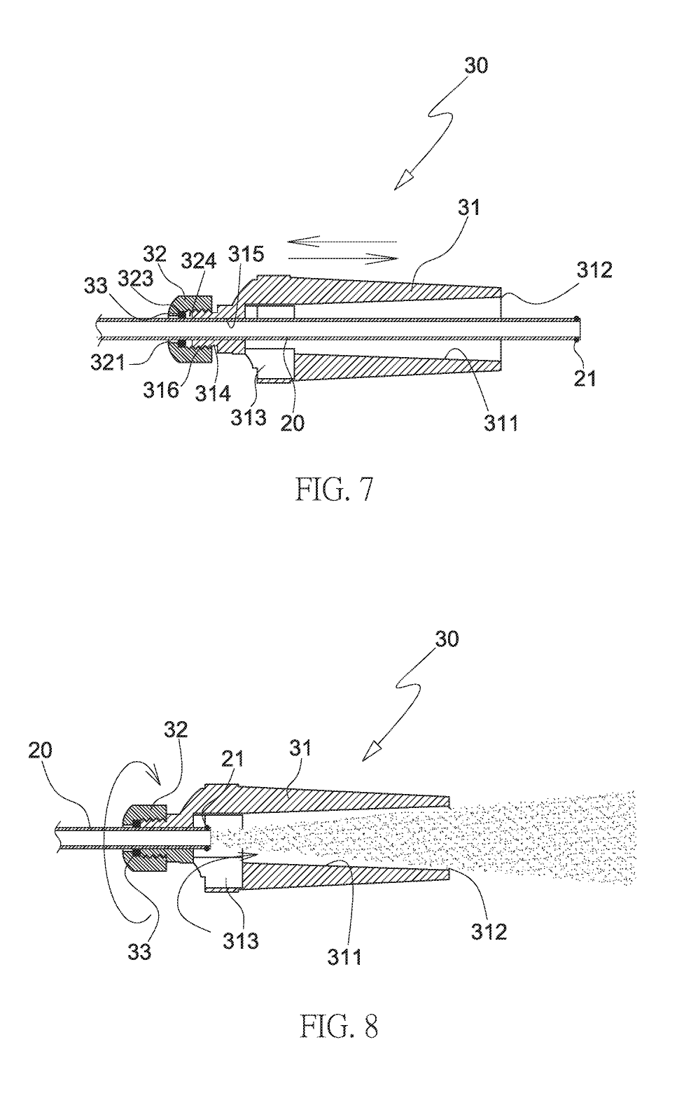

Please refer to FIGS. 5 to 8, another embodiment of the spray head structure of the present invention comprises a spray head 30 which is slidably arranged to the air pipe 20. The spray head 30 further includes a main body 31, a fixing nut 32, and a washer 33. An axial post 314 is arranged at one end of the main body 31. An outer threading section 316 is arranged at an outer edge of the axial post 314. A central hole 315 is passed through the axial post 314. A cone jetting cavity 311 id formed in the main body 31 axially. The cone jetting cavity 311 is aligned with the central hole 315. A divergent opening 312 is formed at the other end of the cone jetting cavity 311. A plurality of inlet holes 313 is formed at the step edge between the main body 31 and the axial post 314. Each inlet hole 313 is fluidly communicated with the central hole 315 and the cone jetting cavity 311. An inner threading section 324 is arranged at an inner edge of the fixing nut 32. Accordingly, the fixing nut 32 may be screwed with the outer treading section 316 of the axial post 314 with the inner threading section 324. Another central hole 321 is passed through the other end of the fixing nut 32 for providing the air pipe 20 to pass through. The air pipe 20 may connected to the cone jetting cavity 311 by passing through the central hole 321 and the central hole 315. A ring cavity 323 is defined between the central hole 312 and the inner threading section 324. One side of the ring cavity 323 has a stop surface 322. The washer 33 is received in the ring cavity 323. One side of the washer 33 is stopped by the stop surface 322. A top edge 317 of the axial post 314 is abutted against the other side of the washer 33. Accordingly, the spray head 30 is slid to the tail end of the air pipe 20 and stopped at a predetermined position in the cone jetting cavity 311 of the main body 31 after the air pipe 20 passes through the central hole 321 of the fixing nut 32. The fixing nut 32 is screwed tightly so that the top edge 317 of the axial post 314 is abutted against the washer 33 t be deformed. The deformed washer 33 may laterally press the air pipe 20 to make the spray head 30 fix to the air pipe 20. When the air is sprayed by the cone jetting cavity 311, the negative pressure is generated in the cone jetting cavity 311 so that the outside air is guided from the inlet hole 313 to the cone jetting cavity 311 and then mixed with the air in the air pipe 20 to spray a large number of air. The spray head 30 may slide relative to the air pipe 20 by screwing out the fixing nut 32 to change the quantities of the sprayed air.

Accordingly, the fixing nut 44 of the spray head 40 may adjustably fix to the air pipe 20 by screw in and out. When fixing, one end of the outer threading section 412 may be abutted against the washer 43 to be deformed. The deformed washer 43 may laterally press the air pipe 20 so as to make the spray head 40 fix to the air pipe 20.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A spray head structure slidably assembled with a nut, comprising a spray head, an air pipe, and a fixing nut, wherein:
the spray head have an outlet member, the outlet member includes a hollow base, an outer threading section is formed at an inner edge of one end of the base, the outer threading section is screwed with an inner threading section of the fixing nut so that a tail end of the outer threading section is abutted against a washer of the fixing nut, an import end is formed in a bottom portion of the base, a head portion is formed at one end of the base, and a nuzzle is extended from the head portion;
one end of the air pipe is arranged in the base of the spray head and the other end of the air pipe is detachably arranged a stop member; and
one end of the fixing nut has an open end and the other end of the fixing end is passed through a central hole for providing the air pipe to pass through and stop at the stop member of the air pipe, a ring cavity is defined between the central hole and the inner threading section, one side of the ring cavity is formed a strop surface, the washer is received in the ring cavity, and one side of the washer is stopped be the stop surface.
